(19) United States
(12) Patent Application Publication
(10) Pub. No.: US 2002/0054833 A1
(43) Pub. Date: May 9, 2002

(54) Use of membrane cover in prevention of cross-contamination in multiple biological material isolation processing

(76) Inventors: Daqing Qu, Chestnut Hill, MA (US); Martin A. Smith, Brookline, MA (US); Andrew M. Mitchell, Cambridge (GB); Neil James Butt, Cambridge (GB); James C. Davis, Kingston, MA (US); Steven J. Kabachus, Quincy, MA (US)

Correspondence Address: David G. Conlin, Esq., DBRC, Intellectual Property Practice Group, Edwards & Angell, LLP, P.O. Box 9196, Boston, MA, 02209, US

(21) Appl. No.: 09/866,152

(22) Filed: May 26, 2001

Related U.S. Application Data
(60) Provisional application No. 60/208,075, filed on May 26, 2000.

(51) Int. Cl. B01L 3/00

(52) U.S. Cl. 422/102; 436/180

(57) ABSTRACT

According to the present invention, there is provided a multiwell device including a multiwell plate having at least one well, wherein each well has an open end portion and a sealing mechanism disposed over each well. The sealing mechanism prevents the loss of contents from each well after the sealing mechanism receives and is penetrated by a material transfer device during a material transfer procedure. Additionally, the present invention provides for a sealing mechanism for being disposed over a plurality of wells of a multiwell plate. The sealing mechanism prevents loss of content from the wells during a material transfer procedure. The present invention also provides for a method of transferring material from the wells of the multiwell device including the steps of puncturing the sealing matrix with the material transfer device and preventing cross-contamination of the content with other wells. Finally, the present invention provides for a method of transferring material from wells of a multiwell device including the steps of puncturing an opening in a sealing matrix, entering the opening with a material transfer device, and preventing cross-contamination of the content with other wells.

### CROSSREFERENCE TO RELATED APPLICATIONS

This application claims the benefit of priority under 35 U.S.C. Section 119(e) of U.S. Provisional patent application Ser. No. 60/208,075, filed May 26, 2000, which is incorporated herein by reference.

### BACKGROUND OF THE INVENTION

1. Field of the Invention

This invention generally relates to the field of biological and biochemical assays, and particularly to a multi-well sampling and filtration device useful in such assays.

2. Description of Related Art

Biological sample isolation is a basis of life science and there is an increasing demand for multiple sample processing. There are numerous devices existing in the market that aid in multiple sample processing. For example, U.S. Pat. No. 5,047,215 discloses a micro-titre test plate including a thermoplastic incubation tray having an array of a plurality of wells extending therethrough, a filter, and a thermoplastic harvester tray for supporting the filter sheet.

Generally, microfiltration plates have a plurality of depressions or cylindrical wells for containing multiple samples. These depressions or cylindrical wells vary in diameter and depth according to a desired use. Typically, the multiwell plates contain ninety-six wells on each plate so that multiple samples can be processed at once and under the same conditions. For instance, there are microfiltration plates fitted with membrane or depth filters to perform simultaneous microfiltration of multiple samples. In order to perform the microfiltration however, a vacuum is required under the plate or pressure is required over the plate to provide a driving force for the filtration to be completed.

Additionally, the multiwell plates are used to incubate, isolate, observe and collect various samples and materials. Moreover, subsequent processing of the samples and material occurs. The subsequent processing includes, but is not limited to, DNA purification, RNA purification, protein purification and chemical separation.

As described above, many multiwell devices include a filtration element so that, upon application of a vacuum to one side of the plate, fluid in each well is expressed through the filter leaving solids, such as bacteria, entrapped in the well. In typical use, specimens from up to ninety-six different samples can be respectively inserted into corresponding wells in the plate in the course of an assay—the samples typically all being inserted prior to filtration and completion of the assay.

Current multiwell plates permit contents from one well to contaminate other wells on the multiwell plate. Contamination generally occurs when the application of pressure or the vacuum causes foaming of the contents. The contamination of contents is highly undesirable because it interferes with the assay and causes ambiguity and confusion in interpretation.

Specifically with the use of a vacuum manifold, foaming of the contents occurs around the top of the wells of the multiwell collection plate. This foaming causes serious cross-contamination among samples in different wells of the multiwell plate. However, due to the complex nature of the foaming, there is no simple, effective and low-cost method available for the prevention or elimination of this problem.

Accordingly, there is a need for a device that prevents cross-contamination among the wells. Specifically, there is a need for a device that provides for a simple, effective, reliable, and low-cost method for cross-contamination prevention in multi-well isolation devices such as filter plates.

### SUMMARY OF THE INVENTION

According to the present invention, there is provided a multiwell device including a multiwell plate having at least one well, wherein each well has an open end portion and a sealing mechanism disposed over each well. The sealing mechanism prevents the loss of contents from each well after the sealing mechanism receives and is penetrated by a material transfer device during a material transfer procedure. Additionally, the present invention provides for a sealing mechanism for being disposed over a plurality of wells of a multiwell plate. The sealing mechanism prevents loss of content from the wells during a material transfer procedure. The present invention also provides for a method of transferring material from the wells of the multiwell device including the steps of puncturing the sealing matrix with the material transfer device and preventing cross-contamination of the content with other wells. Finally, the present invention provides for a method of transferring material from wells of a multiwell device including the steps of puncturing an opening in a sealing matrix, entering the opening with a material transfer device, and preventing cross-contamination of the content with other wells.

### DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an embodiment of the present invention;

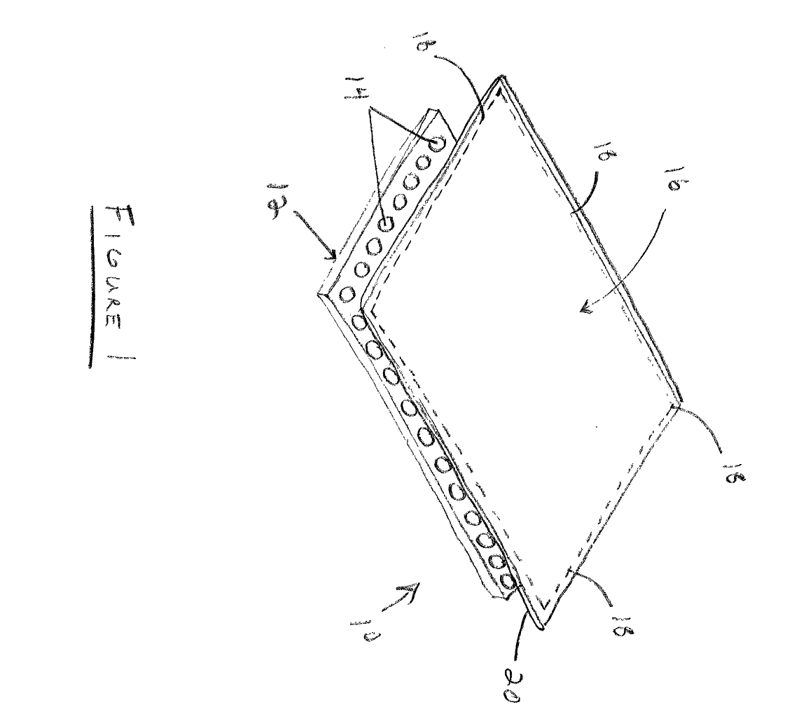

FIG. 2 is a perspective view of another embodiment of the present invention; and

FIG. 3 is side view of an embodiment of the present invention.

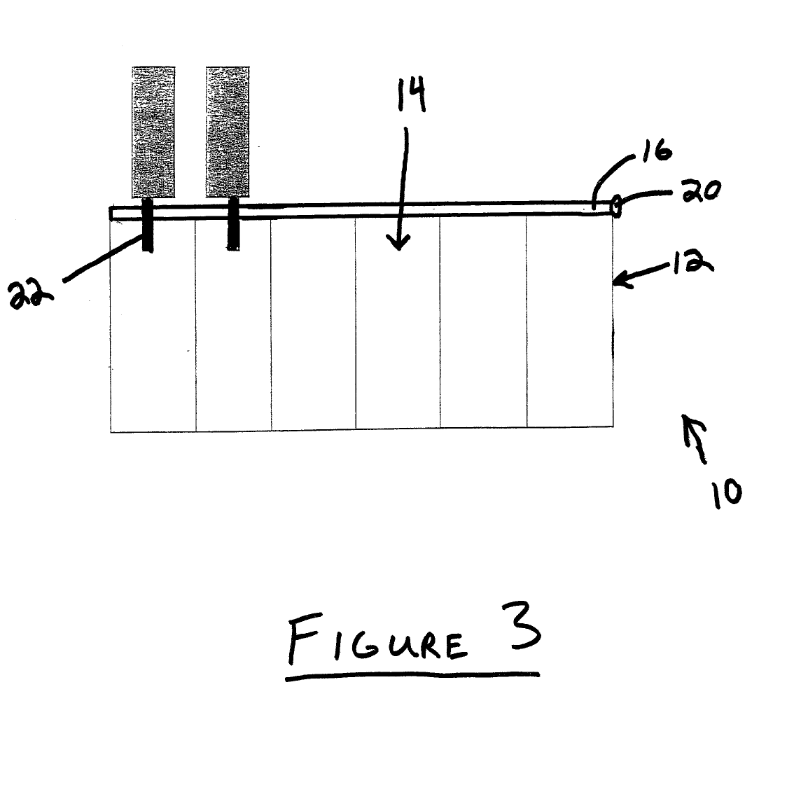

### DETAILED DESCRIPTION OF THE INVENTION

The present invention, generally shown at 10, provides a multiwell device for use in multiple sample processing. Preferably, the present invention includes a multiwell plate (12) such as those commonly used in the art. The multiwell plate (12) includes at least one well (14) and a sealing mechanism (16) disposed over each well (14).

The present invention is well suited for use in numerous settings. These settings include, but are not limited to, laboratories, hospitals, medical settings, and any other similar scientific setting known to those of skill in the art. Additionally, the present invention is used for various processes including, but not limited to, biological sample purification, separation processes, incubation processes, isolation, observation, collection, DNA purification, RNA purification, protein purification, chemical separation, washing processes, and any other scientific processes known to those of skill in the art. The present invention is also compatible for use in various subsequent processes including, but not limited to, ELISA, RIA, Dot immunoblotting, DNA sequencing, DNA labeling and detection, receptor binding assays, membrane capture assays, bead or cell washings, and any other scientific processing applications known to those of skill in the art.

The multiwell plate (12) component of the present invention is known to those of skill in the art of sample processing. Typically, the multiwell plate (12) includes ninety-six depressions or cylindrical wells (14) evenly disposed upon the multiwell plate (12). The depth, width and shape of the wells (14) vary according to the desired use and amount of contents to be sampled and processed.

Generally, the sealing mechanism (16) is a matrix made from material including, but not limited to, glass filter, polyethylene, polypropylene, polysulphone, PVDF, polyester, rubber, cellulose, ethylene and propylene copolymers, polyamides, polymeric material, silicone, films, membranes, combinations thereof, and any other similar elastic material known to those of skill in the art of membrane and matrix technology. The sealing mechanism (16) is preferably hydrophobic, but can also be hydrophilic. Additionally, the sealing mechanism (16) generally is elastic and resilient. The sealing mechanism (16) is placed on top of the multiwell plate (12) and over the open ends of the wells (14). In order to maintain the sealing mechanism (16) positioned over the open ends of the wells (14), various attaching mechanisms (18) are used. The attaching mechanisms (18) include, but are not limited to, heat seals, impulse seals, elastic, glue, adhesive, clips, fasteners, and any other similar attaching mechanism known to those of skill in the art. In addition to the attaching mechanism (18), a guard plate collar (20) can be attached to the sealing mechanism (16) to provide added support and structure.

Preferably, the sealing mechanism (16) is sealed and joined to the multiwell plate (12) through heat or impulse seals or adhesives applied directly to the outer edges of the sealing mechanism (16) and the multiwell plate (12). Self-sealing of each individual well (14) occurs however, during the material transfer procedure. Alternatively, the sealing mechanism (16) can be sealed, through heat or otherwise, around each individual well (14) in order to form a tight seal between the sealing mechanism (16) and the around circumference of each well (14) of the multiwell plate (12).

The sealing mechanism (16) is thin enough to allow itself to be punctured by a material transfer device (22), such as a pipette tip, with little effort. Yet, the sealing mechanism (16) maintains its structural integrity about the tip to effectively prevent spillage from the sealed well (14) during material transfer. Likewise, the sealing mechanism (16) maintains the effective seal about the well (14) opening during this process. Accordingly, material can be transferred through an opening in the sealing mechanism (16), made by the pipette tip, while the sealing mechanism (16) prevents cross-contamination with another well (14). If the sealing mechanism (16) is heat sealed around the edges of the multiwell plate (12), then as the material transfer device (22) punctures the sealing mechanism (16), the sealing mechanism (16) automatically seals each individual well (14) around each well's (14) circumference. Thus, the self-sealing function of the sealing mechanism (16) prevents spatter and spillage of the content from the well (14).

More specifically, once a material transfer device (22) punctures the sealing mechanism (16), spatter is prevented from leaving the well (14). Thus, the sealing mechanism (16) prevents the loss of content from the well (14). The spatter often occurs during procedures involving the use of a vacuum because foaming occurs near the top of the well, which leads to spillage and spatter of the contents of the well (14). Any material transfer device (22) is used with the present invention including, but not limited to, a needle, drip directors, pipettes, plastic tubing, and any other similar transferring device known to those of skill in the art.

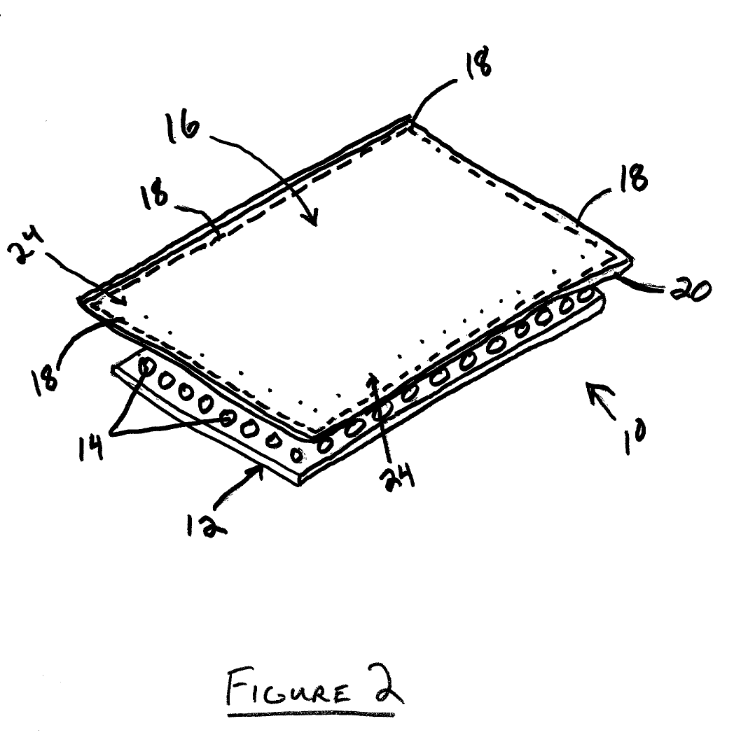

In another embodiment of the present invention, the sealing mechanism (16), as shown in FIG. 2, has openings (24) punctured into the sealing mechanism (16). The openings (24) are located directly over each well (14). The openings (24) range and vary in size and shape. Preferably, the openings (24) will be circular and will have diameters less than the diameter of each well (14) opening. Moreover, at the same time, the openings (24) must be small enough to provide a tight seal around the material transfer device (22) used to enter and to penetrate the sealing mechanism (16). The openings (24) are made utilizing any sharp device, such as a pin or needle, or any puncturing device known to those of skill in the art. Additionally, any puncturing method known to those of skill in the art is suitable in manufacturing the sealing mechanism (16) with the openings (24). Preferably, the openings (24) are punctured into the sealing mechanism (16) before the entire sealing mechanism (16) is placed and sealed upon the multiwell plate (12).

In operation, the present invention provides for a method of transferring material from wells of a multiwell device including the steps of puncturing the sealing matrix with the material transfer device and preventing cross-contamination of the content within other wells. The puncturing of the sealing matrix forces the sealing matrix against the circumference of the well opening and thus self-sealing about the well opening effectively occurs. The self-seal prevents the contents within the well from spilling into other wells of the multiwell plate. Alternatively, self-sealing inherently occurs when the sealing matrix is sealed, through heat or otherwise, directly around the circumference of each individual well on the multiwell plate.

In another operation, the present invention provides for a method of transferring material from wells of a multiwell device including the steps of puncturing an opening in a sealing matrix, penetrating the opening with a material transfer device, and preventing cross-contamination of a content with other wells. As this method describes, the sealing mechanism is not punctured by the material transfer device itself. Instead, the material transfer device merely enters and penetrates the previously punctured opening and then forms a tight seal thereafter to prevent cross contamination of the content with other wells.

Throughout this application, various publications, including U.S. patents, are referenced by author and year and by patent number. Full citations for the publications are listed below. The disclosures of these publications and patents in their entireties are hereby incorporated by reference into this application in order to describe more fully the state of the art to which this invention pertains.

The invention has been described in an illustrative manner, and it is to be understood that the terminology used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described. CLAIMS

What is claimed is:

1. A multiwell device comprising:
a multiwell plate including at least one well, wherein each said well includes an open end portion; and
sealing means disposed over each said well for receiving and being penetrated by a material transfer device and preventing loss of a content from each said well during a material transfer procedure.

2. The multiwell device according to claim 1, wherein said multiwell plate includes ninety six depressions evenly disposed upon said multiwell plate.

3. The multiwell device according to claim 1, wherein said sealing means is made from material selected from the group consisting essentially of glass filter, polyethylene, polypropylene, polysulphone, PVDF, polyesters, rubber, cellulose, ethylene and propylene copolymers, polyamides, polymeric material, and silicone.

4. The multiwell device according to claim 1, wherein said sealing means is defined as being hydrophobic.

5. The multiwell device according to claim 1, wherein said sealing means includes attaching means for attaching said sealing means to said multiwell device.

6. The multiwell device according to claim 5, wherein said attaching means is selected from the group consisting essentially of heat seal, impulse seal, elastic, glue, adhesive, clips, and fasteners.

7. The multiwell device according to claim 6, wherein said attaching means further includes a guard plate collar.

8. The multiwell device according to claim 1, wherein said sealing means includes openings located over each said well.

9. The multiwell device according to claim 1, wherein said sealing means is punctured by said material transfer device.

10. The multiwell device according to claim 9, wherein said material transfer device includes devices selected from the group consisting essentially of a needle, drip directors, pipettes, and plastic tubing.

11. A sealing means disposed over a plurality of wells of a multiwell plate for receiving and being penetrated by a material transfer device and preventing loss of a content from said wells during a material transfer procedure.

12. The sealing means according to claim 11, wherein said sealing means is made from material selected from the group consisting essentially of glass filter, polyethylene, polypropylene, polysulphone, PVDF, polyesters, rubber, cellulose, ethylene and propylene copolymers, polyamides, polymeric material, and silicone.

13. The sealing means according to claim 11 is defined as being hydrophobic.

14. The sealing means according to claim 11, including attaching means for attaching said sealing means to the multiwell plate.

15. The sealing means according to claim 14, wherein said attaching means is selected from the group consisting essentially of a heat seal, an impulse seal, elastic, glue, adhesive, clips, and fasteners.

16. The sealing means according to claim 15, wherein said attaching means further includes a guard plate collar.

17. The sealing means according to claim 11, including openings located over each well.

18. The sealing means according to claim 11, defined as being punctured by a material transfer device.

19. The multiwell device according to claim 18, wherein the material transfer device includes devices selected from the group consisting essentially of a needle, drip directors, pipettes, and plastic tubing.

20. A method of transferring material from wells of a multiwell device comprising the steps of:
puncturing a sealing matrix with a transfer device; and
preventing cross-contamination of a content with other wells.

21. The method according to claim 20, wherein said puncturing step is defined as forcing the transfer device through the sealing matrix and forcing the matrix against a circumference of a well opening, effectively self-sealing about the well opening.

22. The method according to claim 20, wherein said preventing step is defined as preventing the contents within the wells from spilling into other wells of the multiwell device.

23. A method of transferring material from wells of a multiwell device comprising the steps of:
puncturing an opening in a sealing matrix;
penetrating the opening with a material transfer device; and
preventing cross-contamination of a content with other wells.

24. The method according to claim 23, wherein said penetrating step is defined as entering the opening of the sealing matrix with the material transfer device and forcing the matrix against a circumference of a well opening, effectively self-sealing about the well opening.

25. The method according to claim 23, wherein said preventing step is defined as preventing the contents within the wells from spilling into other wells of the multiwell device.
